(19) United States
(12) Patent Application Publication
(10) Pub. No.: US 2024/0015655 A1
(43) Pub. Date: Jan. 11, 2024

(54) Method And Apparatus For Low Power Wake-Up Signal Transmission

(71) Applicant: MediaTek Inc., Hsinchu City (TW)

(72) Inventors: Chien-Chun Cheng, Hsinchu City (TW); Wei-De Wu, Hsinchu City (TW); Yi-Ju Liao, Hsinchu City (TW)

(21) Appl. No.: 18/209,923

(22) Filed: Jun. 14, 2023

Related U.S. Application Data
(60) Provisional application No. 63/368,091, filed on Jul. 11, 2022.

(51) Int. Cl. H04W 52/02; H04L 27/02; H04L 27/26

(52) U.S. Cl. CPC H04W 52/0235; H04L 27/02; H04L 27/2666

(57) ABSTRACT

Various solutions for low power wake-up signal (LP-WUS) transmission with respect to user equipment and network apparatus in mobile communications are described. An apparatus may receive a wake-up signal (WUS) configuration from a network node. The apparatus may monitor a wake-up signal based on the WUS configuration. The wake-up signal may be modulated based on one-off keying (OOK) and generated by a multi-carrier amplitude shift-keying (MC-ASK) waveform generation, and wherein a parameter K is a size of inverse fast Fourier transform (IFFT) of cyclic-prefix orthogonal frequency-division multiple access (CP-OFDMA).

### CROSS REFERENCE TO RELATED PATENT APPLICATION(S)

The present disclosure is part of a non-provisional application claiming the priority benefit of U.S. Patent Application No. 63/368,091, filed 11 Jul. 2022, the content of which herein being incorporated by reference in its entirety.

### TECHNICAL FIELD

The present disclosure is generally related to mobile communications and, more particularly, to low power wake-up signal (LP-WUS) transmission with respect to user equipment (UE) and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to achieve 5G network power savings. There are many conflicts among performance metrics. Quality of service (QoS) and power savings may need a tradeoff. Some local optimal solutions may not achieve the global/overall optimum. For example, the wake-up signal (WUS) saving user equipment (UE) power by 20% may degrade 30% of base station (BS) power savings.

The 5G devices may require charging per week or day based on usage of the user. In general, the 5G devices may consume tens of milliwatts in the radio resource control (RRC) idle state and in the inactive state, and consume hundreds of milliwatts in the RRC connected state. The power consumption may depend on a wake-up period, e.g., the paging cycle. Although the long discontinuous reception (DRX) cycle can be used to extend the battery life, high latency may be generated. Therefore, the long DRX cycle may be unsuitable for such services with the requirements of both long battery life and low latency.

For example, the fire shutters should be closed in an event that fire is detected, and the fire sprinklers should be turned on by the actuators within 1 to 2 seconds if the fire is detected. In this case, the long DRX cycle may not meet the emergency requirements.

Accordingly, how to achieve the requirements of long battery life (i.e., low power consumption) and low latency at the same time becomes an important issue for the newly developed wireless communication network. Therefore, there is a need to provide proper schemes and designs for the wake-up signal (WUS) transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to LP-WUS transmission in mobile communications. It is believed that the above-described issue would be avoided or otherwise alleviated by implementing one or more of the proposed schemes described herein.

In one aspect, a method may involve an apparatus receiving a WUS configuration from a network node. The method may also involve the apparatus monitoring a wake-up signal based on the WUS configuration. The wake-up signal may be modulated based on one-off keying (OOK) and generated by a multi-carrier amplitude shift-keying (MC-ASK) waveform generation, and wherein a parameter K is a size of inverse fast Fourier transform (IFFT) of cyclic-prefix orthogonal frequency-division multiple access (CP-OFDMA).

In another aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a wake-up signal (WUS) configuration from the network node; and monitoring a wake-up signal based on the WUS configuration. The wake-up signal may be modulated based on OOK and generated by an MC-ASK waveform generation, and wherein a parameter K is a size of IFFT of CP-OFDMA.

In another aspect, a method may involve an apparatus transmitting a WUS configuration to a UE. The method may also involve the apparatus modulating a wake-up signal based on OOK and generating the wake-up signal by an MC-ASK waveform generation, and wherein a parameter K is a size of IFFT of CP-OFDMA. The method may also involve the apparatus transmitting the wake-up signal based on the WUS configuration to the UE.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a sequence-based low power (LP)-WUS detection under schemes in accordance with implementations of the present disclosure.

FIG. 2 is a diagram depicting an example scenario of an active LP-WUR with primary synchronization signal (PSS) and secondary synchronization signal (SSS) synchronization under schemes in accordance with implementations of the present disclosure.

FIG. 3 is a diagram depicting an example scenario of PSS and SSS synchronization under schemes in accordance with implementations of the present disclosure.

FIG. 4 is a diagram depicting an example scenario of a sliding correlator under schemes in accordance with implementations of the present disclosure.

FIG. 5 is a diagram depicting an example scenario of an active LP-WUR with LP-synchronization signal (LP-SS) under schemes in accordance with implementations of the present disclosure.

FIG. 6 is a diagram depicting another example scenario of an active LP-WUR with LP-SS under schemes in accordance with implementations of the present disclosure.

FIG. 7 is a diagram depicting an example scenario of the RRM measurements under schemes in accordance with implementations of the present disclosure.

FIG. 8 is a diagram depicting an example scenario of a passive LP-WUR under schemes in accordance with implementations of the present disclosure.

FIG. 9 is a diagram depicting an example scenario of a LP-WUS allocation under schemes in accordance with implementations of the present disclosure.

FIG. 10 is a diagram depicting an example scenario of a resource element (RE) for LP-WUS under schemes in accordance with implementations of the present disclosure.

FIG. 11 is a diagram depicting an example scenario of a resource block (RB) for LP-WUS under schemes in accordance with implementations of the present disclosure.

FIG. 12 is a diagram depicting an example scenario of a beamforming scheme for LP-WUS in the TDD manner under schemes in accordance with implementations of the present disclosure.

FIG. 13 is a diagram depicting an example scenario of a beamforming scheme for LP-WUS in the spatial multiplexing manner under schemes in accordance with implementations of the present disclosure.

FIG. 14 is a diagram depicting an example scenario of a beamforming scheme for multi-slots LP-WUS in the spatial multiplexing manner under schemes in accordance with implementations of the present disclosure.

FIG. 15 is a diagram depicting an example scenario of a beamforming scheme for multi-slots and multi-carriers LP-WUS in the spatial multiplexing manner under schemes in accordance with implementations of the present disclosure.

FIG. 16 is a diagram depicting an example scenario of PWUS and SWUS detections under schemes in accordance with implementations of the present disclosure.

FIG. 17 is a diagram depicting an example scenario of an interface between the main transceiver and the LP-WUR under schemes in accordance with implementations of the present disclosure.

FIG. 18 is a diagram depicting an example scenario of LP-WUS and PEI configurations under schemes in accordance with implementations of the present disclosure.

FIG. 19 is a diagram depicting an example scenario of a UE-group LP-WUS configuration under schemes in accordance with implementations of the present disclosure.

FIG. 20 is a diagram depicting an example scenario of an MME-level UE grouping for the paging under schemes in accordance with implementations of the present disclosure.

FIG. 21 is a diagram depicting an example scenario of a RAN-level UE grouping for the paging under schemes in accordance with implementations of the present disclosure.

FIG. 22 is a diagram depicting an example scenario of collisions handling between the LP-WUS and SSB/SIB under schemes in accordance with implementations of the present disclosure.

FIG. 23 is a diagram depicting an example scenario of a non-zero gap under schemes in accordance with implementations of the present disclosure.

FIG. 24 is a diagram depicting an example scenario of a LP-WUS process under schemes in accordance with implementations of the present disclosure.

FIG. 25 is a block diagram of an example communication system in accordance with an implementation of the present disclosure.

FIG. 26 is a flowchart of an example process in accordance with an implementation of the present disclosure.

FIG. 27 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to LP-WUS transmission in mobile communications. According to the present disclosure, a number of possible solutions may be implemented separately or jointly. That is, although these possible solutions may be described below separately, two or more of these possible solutions may be implemented in one combination or another.

In the radio resource control (RRC) connected mode, when the main transceiver (or main radio) of the user equipment (UE) is turned off or in a sleeping mode, the UE may have low mobility and maintain downlink (DL) synchronization. The UE may apply a wake-up signal (WUS) for paging monitoring. The paging occasion (PO) monitoring is required only when the WUS is received, which may occur with low probability. The interval between the WUS and the synchronization signal block (SSB) may be 3 milliseconds (ms) and a microsleep may be present between the WUS and the SSB.

For the legacy WUS transmission (i.e., physical downlink control channel (PDCCH)-based WUS) scenario, the interval between WUS and the start of discontinuous reception (DRX)-On duration may be 1 ms. The PDCCH monitoring in the DRX-ON period is required only when the WUS is received. In addition, for the PDCCH-based WUS, when the WUS is received, another PDCCH monitoring may be required for DCI format 2_6, i.e., the main transceiver of the UE may need to be waked up for the PDCCH monitoring. Therefore, more power consumption may be generated.

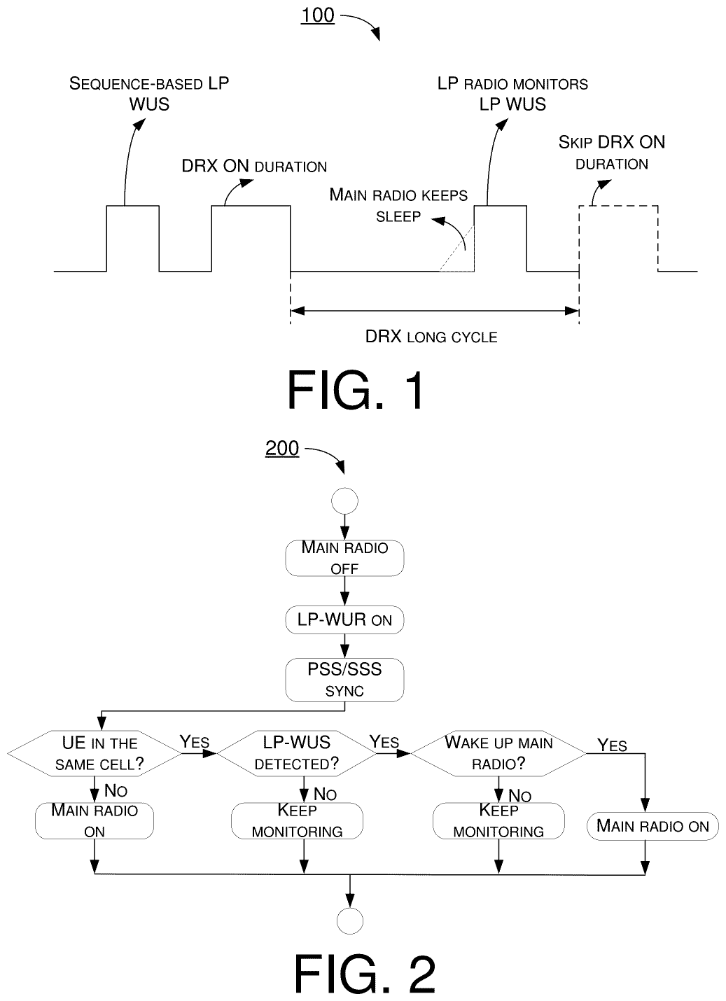

FIG. 1 illustrates an example scenario 100 for a sequence-based low power (LP)-WUS detection under schemes in accordance with implementations of the present disclosure. Scenario 100 involves a network node (e.g., a macro base station and multiple micro base stations) and a UE, which may be a part of a wireless communication network (e.g., an LTE network, a 5G/NR network, an IoT network or a 6G network). Referring to FIG. 1, a sequence-based LP-WUS is applied in the DRX cycle. The sequence-based LP-WUS detection may be performed by an independent LP transceiver (or LP radio) of the UE. Therefore, when the LP-WUS is received, the main transceiver of the UE may stay asleep and/or enter a deeper sleep mode. That is, when the LP-WUS is received, the UE may perform a sequence (i.e., LP-WUS) detection though the LP transceiver without performing another PDCCH monitoring though the main transceiver. In an implementation, the LP-WUS may be modulated based on one-off keying (OOK) or binary phase-shift keying (BPSK) and generated by a multi-carrier amplitude shift-keying (MC-ASK) waveform generation, and wherein a parameter K is a size of inverse fast Fourier transform (IFFT) of cyclic-prefix orthogonal frequency-division multiple access (CP-OFDMA).

In an implementation, an active LP wake-up receiver (LP-WUR) (i.e., LP transceiver) of the UE may use a small amount of power from the host device battery. In an example, if a WUS is detected by the LP-WRU, the LP-WRU of the UE may wake the main transceiver of the UE. In another example, if a WUS is detected by the LP-WRU, the LP-WRU of the UE may keep monitoring the WUS without waking the main transceiver of the UE. Therefore, the LP-WUR may reduce the overall power when the main transceiver is turned off or enter a sleep mode.

The active LP-WUR can decode the signals with following types. In an example, the signals may be OOK-based tone signals which may be used for non-coherent energy detection. In another example, the signals may be frequency domain orthogonal sequences. In another example, the signals may be simplified PDCCH-like channel which may be used for subsampled and lower complexity decoding.

The UE may determine whether a synchronization time for the LP-WUR is needed and transmit a report to the network node based on the determination result. The UE may receive multiple WUR configurations from the network node when an additional synchronization time is necessary. The UE may determine to apply at least one of the WUR configurations according to its hardware implementation or UE capability.

FIG. 2 illustrates an example scenario 200 of an active LP-WUR with primary synchronization signal (PSS) and secondary synchronization signal (SSS) synchronization under schemes in accordance with implementations of the present disclosure. Scenario 200 involves a network node (e.g., a macro base station and multiple micro base stations) and a UE, which may be a part of a wireless communication network (e.g., an LTE network, a 5G/NR network, an IoT network or a 6G network). Referring to FIG. 2, the UE may perform PSS and SSS synchronization. That is, the UE may perform the synchronization based on a SSB or physical broadcast channel (PBCH) block through the LP-WUR. Then, the UE may determine whether the UE is in the same cell for idle paging. If the cell identifier (ID) has changed, the UE may determine that the UE is not in the same cell during the PSS and SSS synchronization, and then, the main transceiver of the UE may be turned on and cell re-selection will be triggered. If the cell ID has not changed, the UE may determine that the UE is in the same cell during the PSS and SSS synchronization, and then the UE may detect whether the LP-WUS is detected.

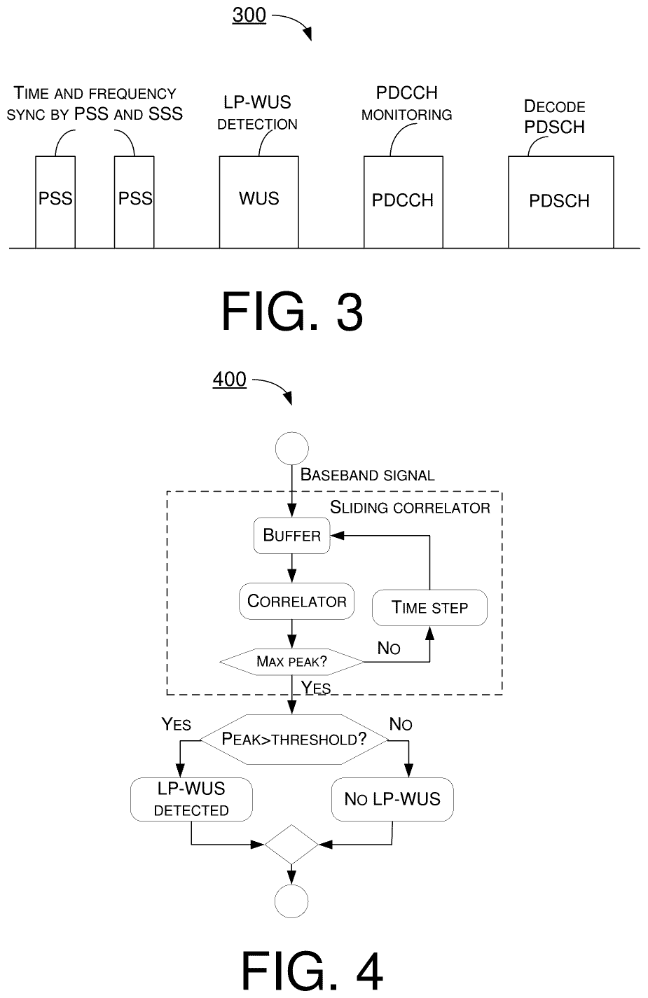

FIG. 3 illustrates an example scenario 300 of PSS and SSS synchronization under schemes in accordance with implementations of the present disclosure. Scenario 300 involves a network node (e.g., a macro base station and multiple micro base stations) and a UE, which may be a part of a wireless communication network (e.g., an LTE network, a 5G/NR network, an IoT network or a 6G network). Referring to FIG. 3, the UE may perform time and frequency synchronization based on the PSS and SSS. The UE may detect the LP-WUS. If LP-WUS is detected, the UE may perform the PDCCH monitoring. In addition, if downlink control information (DCI) is detected, the UE may decode the physical downlink shared channel (PDSCH).

For RRC IDLE mode, when the UE wakes up with an extended DRX (eDRX) cycle of the 60 seconds, the time drift may lead to a timing offset and a frequency offset.

For the LP-WUS, if the LP-WUR can perform pre-synchronization through legacy PSS and SSS, the repetitions at maximum coupling loss (MCL) may be sufficient to make the missed WUS detection probability less than a threshold. It may be more efficient to use legacy PSS and SSS for pre-synchronization. Further, it may be more efficient to schedule UE-specific WUS with smaller repetitions to allow reliable detection.

In the implementation of FIG. 2, the UE may acquire downlink (DL) synchronization using existing synchronization mechanisms involving PSS and SSS detection. When the LP-WUS is used to convey 1-bit information, the LP-WUS may use fewer resources than the PDCCH. Therefore, decoding or detecting the 1-bit LP-WUS with prior DL synchronization through a threshold-based detection may require fewer resources.

In the implementation of FIG. 2, it may be expected that a low probability of missed detection may occur when the UE has waveform synchronization and the channel state information may be sufficient to demodulate synchronization patterns within the WUS. However, the power savings may be decreased due to the cost of reading the synchronization signals. Therefore, a non-coherent detector may be used to detect the WUS.

FIG. 4 illustrates an example scenario 400 of a sliding correlator under schemes in accordance with implementations of the present disclosure. Scenario 400 involves at least a UE. Referring to FIG. 4, a sliding correlator with a buffer may be used to accommodate the time drift through time steps. If needed, the frequency steps may be also applied to adjust the frequency drift. It is assumed that the received baseband (BB) signal is roughly synchronized from the pre-sync stage using the legacy narrowband PSS (NPSS) and narrowband SSS (NSSS).

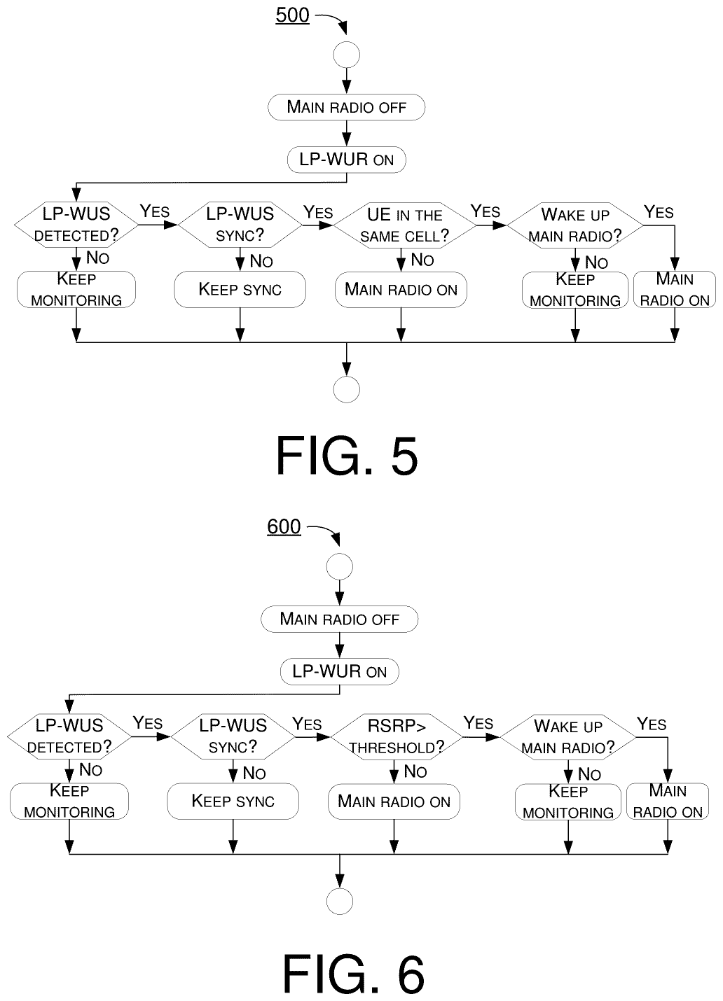

FIG. 5 illustrates an example scenario 500 of an active LP-WUR with LP-synchronization signal (LP-SS) under schemes in accordance with implementations of the present disclosure. Scenario 500 involves a network node (e.g., a macro base station and multiple micro base stations) and a UE, which may be a part of a wireless communication network (e.g., an LTE network, a 5G/NR network, an IoT network or a 6G network). Referring to FIG. 5, if there is no DL synchronization (i.e., no PSS and SSS for DL synchronization), the UE may use the LP-SS for timing estimation when the UE wakes to listen or detect the LP-WUS. In an example, the LP-SS may comprise a LP-WUS preamble. The WUS function may signal/configure the UE to indicate that the UE needs to wake up to complete a response for a paging request.

Before entering the sleep state, the LP-WUR may establish a WUR epoch (e.g., reference point in time and frequency). It may allow the LP-WUR to execute a time-frequency search across a two-dimensional window that may span the time of arrival (TOA) and carrier frequency offset (CFO) uncertainties. A non-coherent detection of the LP-WUS preamble may be performed at each TOA step and/or CFO step, and the power sample may be stored in the corresponding time-frequency detection grid location.

For LP-WUS, the UE may assume that a single antenna port, a single subcarrier spacing (e.g., 15 kHz for frequency range 1 (FR1) and 60 kHz for FR2), and a LP-WUS transmitted with the same index may be quasi co-located (QCLed) for doppler spread, doppler shift, average gain, average delay, delay spread and spatial Rx parameters.

In an example, the UE may use the LP-WUS for an initial time and frequency synchronization when first accessing a cell. In another example, the UE may use the LP-WUS for identifying the Physical layer Cell Identity (PCI) belonging to a cell, where NR may support 1008 PCIs, which are organized into 336 groups of 3. In another example, the UE may use the LP-WUS for completing the reference signal received power (RSRP), reference signal received quality (RSRQ), and signal to interference noise ratio (SINR) measurements.

The LP-WUS may be sequences of [127×2] BPSK symbols or sequences of [127×2] on-off keying (OOK) symbols that are mapped onto [127×2] resource elements (REs). The LP-WUS may be generated by applying one of 3 three cyclic shifts to a sequence or regarded as a product of two sequences.

The sequences used for LP-WUS may have a good auto-correlation properties, i.e., each sequence may generate a high result when correlated with a synchronized version of itself and generate a low result when correlated with an unsynchronized version of itself. In addition, sequences used for LP-WUS may have good cross-correlation properties, i.e., the sequence generates a low result when correlated with other sequences.

FIG. 6 illustrates another example scenario 600 of an active LP-WUR with LP-synchronization signal (LP-SS) under schemes in accordance with implementations of the present disclosure. Scenario 600 involves a network node (e.g., a macro base station and multiple micro base stations) and a UE, which may be a part of a wireless communication network (e.g., an LTE network, a 5G/NR network, an IoT network or a 6G network). Referring to FIG. 6, in the implementations, the UE may determine whether the cell ID is the same based on the received power of LP-WUS. When the RSRP of LP-WUS is lower than a configured threshold provided by network node via RRC or system information block (SIB), the LP-WUR may wake up the main transceiver (or main radio) for a possible cell ID change.

In an implementation, the UE may receive a period configuration of LP-WUS from the network node. The LP-SS periodicities may comprise at least one of 320 ms, 640 ms, 1280 ms, 2560 ms, 5120 ms and 10240 ms. The values of LP-SS periodicities may be in ms, seconds, slots, or periods, e.g., SSB-based measurement timing configuration (SMTC) periods. The UE may turn on an LP-WUR to monitor LP-WUS periodically if the period configuration of LP-WUS is configured. The UE may average one or multiple LP-WUS to evaluate whether it stays in the same cell or determine whether it should turn on the main transceiver (or main radio). In an implementation, the UE may allow combining the LP-WUSs from different bursts if the network node broadcasts multiple LP-WUSs in a single burst though different beam directions. In addition, in an implementation, the UE may need to monitor one LP-WUS in the single burst, and repeat monitoring for each period.

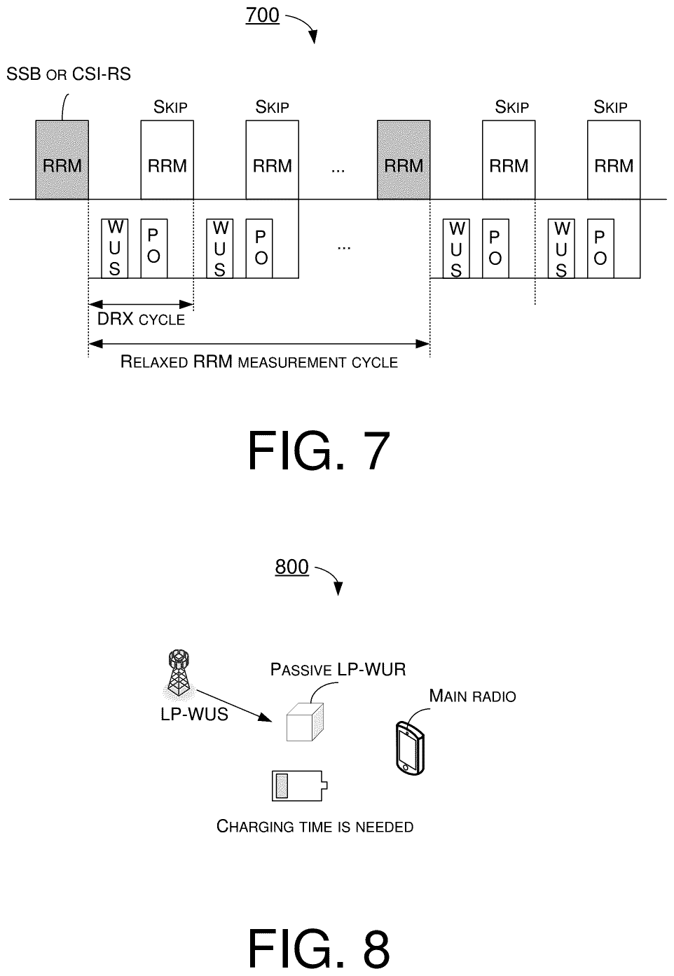

FIG. 7 illustrates an example scenario 700 of the RRM measurements under schemes in accordance with implementations of the present disclosure. Scenario 700 involves a network node (e.g., a macro base station and multiple micro base stations) and a UE, which may be a part of a wireless communication network (e.g., an LTE network, a 5G/NR network, an IoT network or a 6G network). Referring to FIG. 7, for the operations for the LP-WUS, the UE with low mobility may relax RRM measurements (e.g., skip some RRMs during the relax RRM measurement cycle) once every N DRX cycles or once every N e-DRX cycles, wherein N is a positive integer and N may be cell-specific. The UE may report whether the low mobility criterion is satisfied to the network node, wherein the low mobility criterion may be configured by the network node via RRC or SIB. In addition, the UE may receive whether the RRM measurement relaxation is enabled or disabled via RRC or SIB1.

When the main transceiver is turned off, the UE may use LP-SS for synchronization until the N DRX or N e-DRX cycles are not synchronized because of the timing offset and/or frequency offset. The timing offset and frequency offset may occur when the RRM measurement relaxation is enabled. Therefore, when the RRM measurement is needed, the LP-WUR may wake up the main radio to measure SSB.

The UE may perform the two-dimensional blind search over time and frequency in the LP-WUR. The UE may receive the blind search range over time and frequency provided by the network node via RRC or SIB, e.g., LP-WUS monitoring duration and LP-WUS monitoring frequency.

The UE may evaluate the cell selection criterion for the serving cell at least once every M1*N1 DRX cycle. In an example, M1=2 if SMTC periodicity >20 ms and DRX cycle≤0.64 second, otherwise M1=1. For RRC idle mode, the UE may measure the synchronization signal (SS)-RSRP and SS-RSRQ levels of the serving cell. The UE may filter the SS-RSRP and SS-RSRQ measurements of the serving cell using at least two measurements. Within the set of measurements used for the filtering, the at least two measurements may be spaced by (DRX cycle/2).

FIG. 8 illustrates an example scenario 800 of a passive LP-WUR under schemes in accordance with implementations of the present disclosure. Scenario 800 involves a network node (e.g., a macro base station and multiple micro base stations) and a UE, which may be a part of a wireless communication network (e.g., an LTE network, a 5G/NR network, an IoT network or a 6G network). Referring to FIG. 8, the passive LP-WUR may use the power of the incident electromagnetic waves as a power source for the receiver circuitry. The radio frequency identification (RFID) tags may be implemented in passive LP-WURs which may be used in security systems and electrical toll collection (ETC) system. The passive LP-WUR may obtain sufficient energy from the incident electromagnetic radiation to perform a response transmission.

The passive LP-WUR may be more suitable for the operations over a shorter distance than the operations over the full NR cell range. The passive LP-WUR may not need to send a response transmission and only need sufficient power to switch on the main WUR (or main radio). However, if there is no battery or no energy storage capability, it may be challenging to activate the passive LP-WUR, i.e., the UE may take hours to charge for a single activation.

The UE may report whether the charging time for the LP-WUR is needed. The UE may receive both passive LP-WUR and active WUR configurations from the network node and the UE may determine to use one of them according to its hardware implementation or UE capability.

In some implementations, the UE may determine an LP-WUS signal in a slot or a subframe.

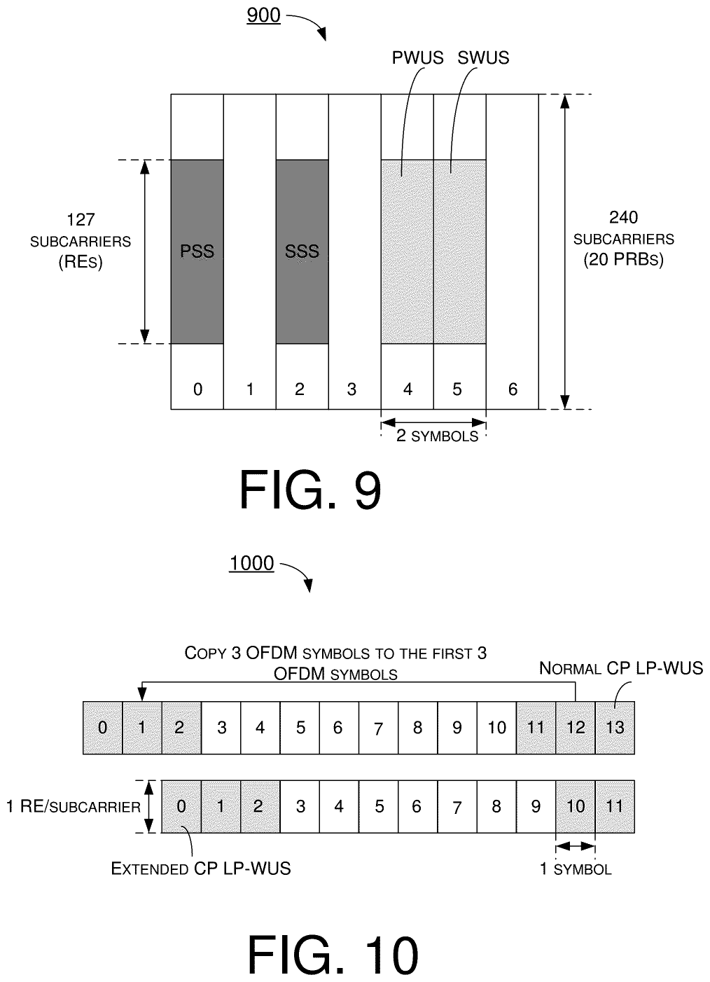

FIG. 9 illustrates an example scenario 900 of a LP-WUS allocation under schemes in accordance with implementations of the present disclosure. Scenario 900 involves a network node (e.g., a macro base station and multiple micro base stations) and a UE, which may be a part of a wireless communication network (e.g., an LTE network, a 5G/NR network, an IoT network or a 6G network). Referring to FIG. 9, in an implementation, the LP-WUSs may comprise 2 OFDM symbols (i.e., primary LP-WUS (PWUS) may comprise one symbol, and the secondary LP-WUS (SWUS) may comprise the other symbol) and 127 REs (subcarriers) located in the same bandwidth part (BWP) as the SSB BWP. The UE may receive a bit map that indicates an LP-WUS burst which comprises the time and frequency information for one or multiple LP-WUS repetitions transmitted by different beam directions. The UE may assume that the LP-WUS from other slots is transmitted by different beam directions.

FIG. 10 illustrates an example scenario 1000 of a resource element (RE) for LP-WUS under schemes in accordance with implementations of the present disclosure. Scenario 1000 involves a network node (e.g., a macro base station and multiple micro base stations) and a UE, which may be a part of a wireless communication network (e.g., an LTE network, a 5G/NR network, an IoT network or a 6G network). Referring to FIG. 10, the LP-WUS may occupy one RE (i.e., single subcarrier) with 15 kHz (or 30 kHz) subcarrier spacing in FR1 or with 120 kHz (or 240 kHz) subcarrier spacing in FR2. The UE may occupy 14 OFDM symbols for normal cyclic prefix (CP) or 12 OFDM symbols for extended CP, i.e., a slot or subframe may comprise 14 OFDM symbols for normal CP or comprise 12 OFDM symbols for extended CP. The first x OFDM symbols in a slot or subframe may be the same as the last x OFDM symbols in the slot or subframe. For example, referring to FIG. 10, the first three OFDM symbols may be the same as the last three symbols in the slot for normal CP.

In the implementations of FIG. 10, the UE may monitor 127×2/12≈22 the subframes or slots for a single LP-WUS when the LP-WUS conveys cell ID via OOK modulation. The UE may receive a duration or an observation window length configured by the network node through SIB or RRC. The UE may assume that the same antenna port, QCL, or beam direction may be within the duration of the observation window.

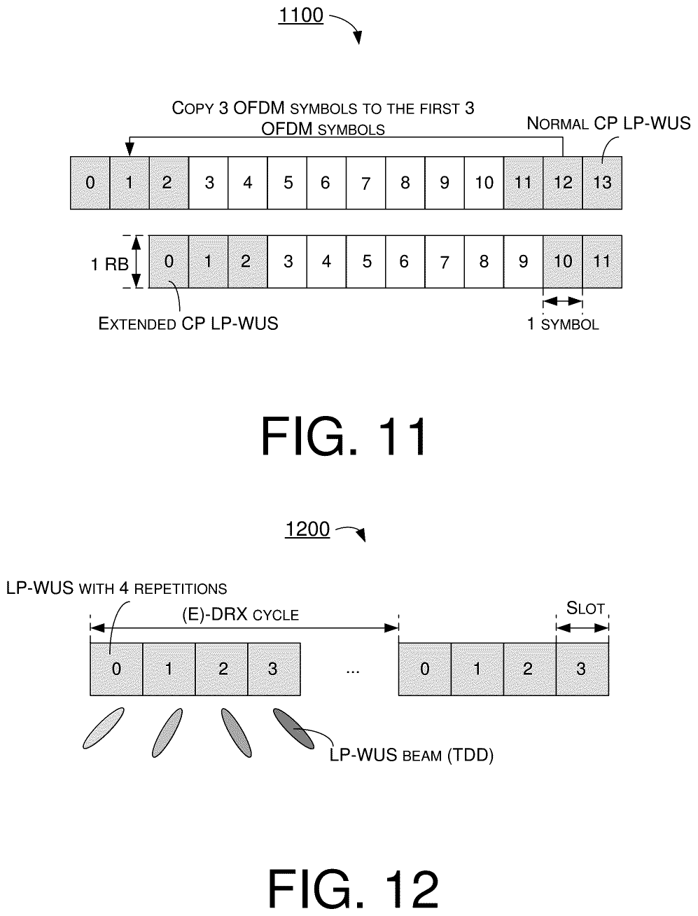

FIG. 11 illustrates an example scenario 1100 of a resource block (RB) for LP-WUS under schemes in accordance with implementations of the present disclosure. Scenario 1100 involves a network node (e.g., a macro base station and multiple micro base stations) and a UE, which may be a part of a wireless communication network (e.g., an LTE network, a 5G/NR network, an IoT network or a 6G network). Referring to FIG. 11, the LP-WUS may occupy one resource block (RB) with 15 KHz or 30 kHz subcarrier spacing in FR1 or with 120 kHz or 240 kHz subcarrier spacing in FR2.

In the implementations of FIG. 11, the UE may use 1 RB as 12 REs to convey the information bits of the LP-WUS. The UE may monitor 127×2/12/12≈2 subframes or slots for a single LP-WUS for carrying the same information provided in PSS and SSS. The RB number and the frequency location may be provided in SIB or RRC.

In an implementation, if the UE obtains coarse synchronization, the UE may monitor multiple subframes or slots when LP-WUS is beamformed in a time division duplex (TDD) manner, e.g., the network node may transmit different beam directions for each slot or subframes. In another implementation, the UE may monitor one subframe or slot when LP-WUS is beamformed in a spatial multiplexing manner, e.g., all beams can be transmitted simultaneously. The transmissions may overlap in the time and frequency domains because they are isolated in the spatial domain.

In an example, when the UE monitors LP-WUS, the UE may assume that the transmission of the LP-WUS in at least one subframe or slot may use the same antenna port. In another example, the UE may not assume that the LP-WUS is transmitted on the same antenna port as any downlink reference or synchronization signals. The UE may assume that the transmission of all WUS subframes may use the same antenna port, or the UE may assume that the transmission of WUS in at least one subframe may use the same antenna port.

FIG. 12 illustrates an example scenario 1200 of a beamforming scheme for LP-WUS in the TDD manner under schemes in accordance with implementations of the present disclosure. Scenario 1200 involves a network node (e.g., a macro base station and multiple micro base stations) and a UE, which may be a part of a wireless communication network (e.g., an LTE network, a 5G/NR network, an IoT network or a 6G network). Referring to FIG. 12, the LP-WUS may be beamformed in the TDD manner. The LP-WUS may comprise four repetitions.

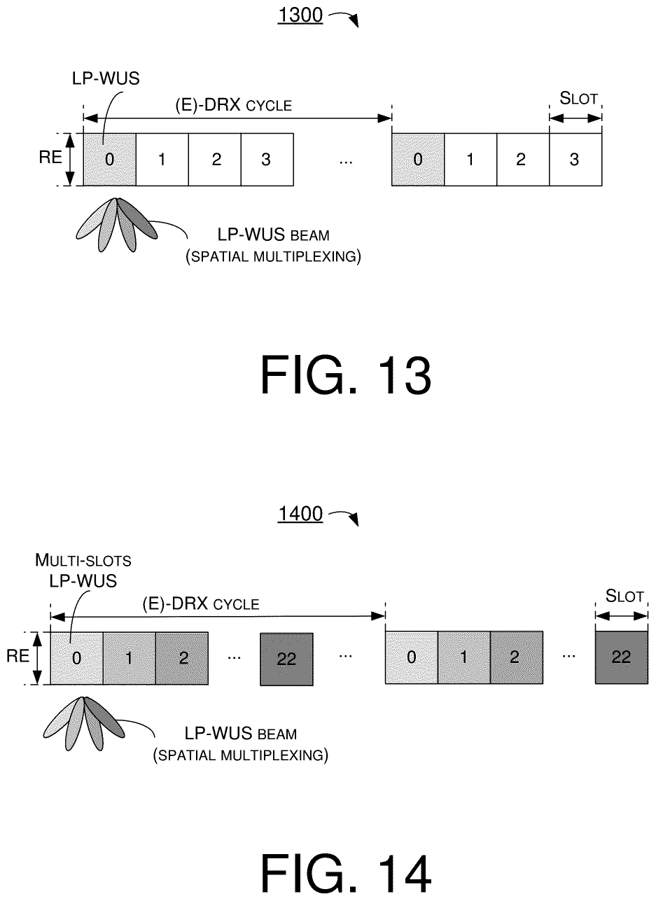

FIG. 13 illustrates an example scenario 1300 of a beamforming scheme for LP-WUS in the spatial multiplexing manner under schemes in accordance with implementations of the present disclosure. Scenario 1300 involves a network node (e.g., a macro base station and multiple micro base stations) and a UE, which may be a part of a wireless communication network (e.g., an LTE network, a 5G/NR network, an IoT network or a 6G network). Referring to FIG. 13, the LP-WUS may be beamformed in the spatial multiplexing manner.

FIG. 14 illustrates an example scenario 1400 of a beamforming scheme for multi-slots LP-WUS in the spatial multiplexing manner under schemes in accordance with implementations of the present disclosure. Scenario 1400 involves a network node (e.g., a macro base station and multiple micro base stations) and a UE, which may be a part of a wireless communication network (e.g., an LTE network, a 5G/NR network, an IoT network or a 6G network). Referring to FIG. 14, the multi-slots LP-WUS may be beamformed in the spatial multiplexing manner.

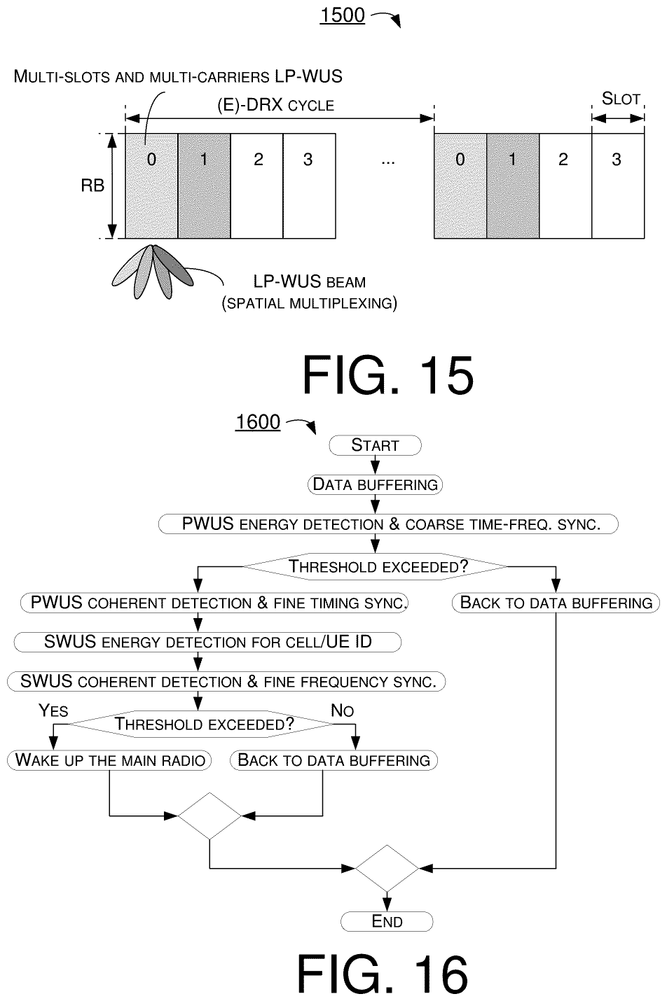

FIG. 15 illustrates an example scenario 1500 of a beamforming scheme for multi-slots and multi-carriers LP-WUS in the spatial multiplexing manner under schemes in accordance with implementations of the present disclosure. Scenario 1500 involves a network node (e.g., a macro base station and multiple micro base stations) and a UE, which may be a part of a wireless communication network (e.g., an LTE network, a 5G/NR network, an IoT network or a 6G network). Referring to FIG. 15, the multi-slots and multi-carriers LP-WUS may be beamformed in the spatial multiplexing manner.

The UE may receive the maximum duration of the LP-WUS configured per cell or carrier component through SIB or RRC. When the UE monitors one or multiple LP-WUSs in the same or different durations, the UE may assume that the actual LP-WUS duration is transmitted aligning to the end or the start of the configured maximum duration of the LP-WUS. The values of the LP-WUS in the duration may be in subframes, slots, symbols, or ms, configured by the network node through RRC or SIB.

When the UE monitors the LP-WUS, the UE may assume that all the REs for the transmission of the LP-WUS in a given subframe or slot may use the same antenna port. However, the UE may not assume that the transmission of LP-WUS in a plurality of consecutive subframes or slots may use the same antenna port.

FIG. 16 illustrates an example scenario 1600 of PWUS and SWUS detections under schemes in accordance with implementations of the present disclosure. Scenario 1600 involves a network node (e.g., a macro base station and multiple micro base stations) and a UE, which may be a part of a wireless communication network (e.g., an LTE network, a 5G/NR network, an IoT network or a 6G network). Referring to FIG. 16, the UE may perform PWUS detections (e.g., PWUS energy detection with coarse time-frequency synchronization and PWUS coherent detection with fine timing synchronization) and SWUS detections (e.g., SWUS energy detection for cell ID or UE ID and SWUS coherent detection with fine frequency synchronization) to determine whether to wake up the main transceiver (or main radio) of the UE or back to the data buffering.

The UE may assume that the LP-WUS may be modulated by OOK or BPSK which is configured in RRC or SIB1. When the UE monitor the LP-WUS, the UE may assume that the LP-WUS may comprise one or more sequences for detecting or selecting the LP-WUS and/or may comprise encoded bits to present the LP-WUS information (e.g., the type of encoding scheme). The sequence may be the Zadoff Chu (ZC)-sequence. The sequence may be configured by the network through RRC or SIB. The sequence may be mapped within one subframe or slot or duration as a basic unit, or repeated or extended for multiple subframes or slots or durations. The sequence may be determined/generated based on a sequence detection or a sequence selection, or based on the encoded bits.

The UE may assume that the orthogonal frequency division multiplexing (OFDM)-based OOK or discrete Fourier transform spread OFDM (DFT-s-OFDM)-based OOK is used to modulate LP-WUS. In addition, the UE may apply additional post-digital processing for the potential waveform distortion. The UE may report its post-compensation capability (e.g., UE assistant information (UAI)) to the network node through RRC. The network node may indicate the modulation types of LP-WUS, e.g., OFDM-based, DFT-s-OFDM-based, or ideal OOK, through RRC or SIB.

The UE may receive LP-WUS sequence configurations from the network node through RRC or SIB. The sequence configurations may comprise a length of ZC, a length of RE-level cover codes, or a RE-level scrambling sequence. The RE-level cover codes may be based on Hadamard codes, Gold sequences, or M sequences configured by the network node through RRC or SIB.

The LP-WUS may convey or associates with at least one of a cell ID, a UE group ID, cell information, time information of the starting subframe of the WUS or a paging occasion (PO), and a system subframe number (SFN) information configured by the network node through SIB or RRC.

Before the LP-WUS detection, the UE may know the cell ID, the timing information (e.g., SFN and subframe index) of the expected PO, and its sub-group ID corresponding to the PO provided in SIB or RRC. Further, according to the non-zero gap and the configured maximum duration of LP-WUS provided in SIB or RRC, the UE may also be able to implicitly derive the timing position (SFN and subframe index) of the start of the LP-WUS. The UE may generate one local sequence and perform one correlation operation. Then, the UE may obtain one correlation value and compare the correlation value with a predefined threshold to decide whether the local sequence is LP-WUS.

When the UE determines that multiple LP-WUSs have different LP-WUS indexes and are not QCLed (implying an LP-WUS beam reception direction), the UE may not perform soft combining on the LP-WUSs. Otherwise, the UE may combine the LP-WUSs when they have the same LP-WUS index.

The LP-WUS may comprise part of the cell ID information, e.g., 21 cell IDs (single-ring) or 57 cell IDs (double-ring), to guarantee good distinction from neighboring cells. The LP-WUS may comprise timing information or index for combining the LP-WUS in multiple subframes or slots.

The primary LP-WUS (PWUS) may be generated by applying 1 of 3 cyclic shifts (e.g., cyclic shifts of 0, 43, and 86) to a sequence of 127 BPSK symbols. The cyclic shift may be regarded as a pointer to 1 of 3 physical cell IDs (PCIs) within a PCI group. The cyclic shifts may lead to 3 versions of the PSS, which may be re-used across the entire network.

The secondary LP-WUS (SWUS) may generated by multiplying two sequences which depend upon both the pointer towards the PCI within the group (e.g., 1 out of 336) and the pointer towards the PCI within another PCI group (e.g., 1 out of 3), i.e., there are 1008 SWUS sequences. The UE may have to identify 1 out of 336 SWUS sequences after the PWUS cyclic shift has been identified.

There may be 1008 unique physical-layer cell identities given by N_{ID}^{cell}=3N_{ID}⁽¹⁾+N_{ID}⁽²⁾, where N_{ID}⁽¹⁾∈{0, 1, . . . , 335} and N_{ID}⁽²⁾∈{0,1,2}.

The sequence d_{pwus}(n) for the primary LP-WUS may be defined by dₚₛₛ(n)=1−2x(m), where m=(n+43N_{ID}⁽²⁾)mod 127, 0≤n<127, x(i+7)=(x(i+4)+x(i))mod 2, and [x(6),x(5),x(4),x(3),x(2),x(1),x(0)]=[1,1,1,0,1,1,0].

The sequence d_{swus}(n) for the secondary LP-WUS may be defended by d_{swus}=[1−2x₀((n+m₀))mod 127][1−2x₁((n+m₁)mod 127)], where m₀=15[N_{ID}⁽¹⁾/112]+5N_{ID}⁽²⁾), m₁=N_{ID}⁽¹⁾ mod 112, 0≤n<127, x₀(i+7)=(x₀(i+4)+x₀(i))mod 2, x₁(i+7)=(x₁(i+4)+x₁(i))mod 2, [x₁(6),x₁(5),x₁(4),x₁(3),x₁(2),x₁(1),x₁(0)]=[0,0,0,0,0,0,1], and [x₀(6),x₀(5),x₀(4),x₀(3),x₀(2),x₀(1),x₀(0)]=[0,0,0,0,0,0,1].

The UE may apply a detector at the receiver to evaluate the correlation between the received signal and a copy of the same signal with a hypothesized time-frequency offset. If the UE finds a peak with a value greater than a threshold, UE may assume that an LP-WUS is detected.

The detailed steps to generate LP-WUS may be shown as following TX steps and RX steps. It is assumed that the sequence occupies 1 ms (1 slot for 15 kHz), and the sequence can be repeated to meet the coverage requirement.

TX step 1: a [x]-length ZC sequence may be generated and denoted by d(n)=e^{-jπ·u·n·(n+1)/x}, where n=0, . . . , x−1 and the root index u is an integer within [1, x−1].

TX step 2: the sequence d(n) may be extended to y-length by cyclic extension to generate a new sequence of s.

TX step 3: the sequence s may be divided into z sub-sequences, and each sub-sequence includes z−1 consecutive elements of s in turn. The sub-sequences may be denoted as x₁, . . . , x_{z}.

TX step 4: A (z−1)-length sequence (x₀) may be predefined as the initial sequence and the accumulated multiplication with x₀, . . . , x_{z} to generate new sequences y₀, . . . , y_{z}, which satisfies $y_i=\prod\hat{ }{i}{j=0}x_j$.

TX step 5: Resource mapping. The sequences y₀, . . . , y_{z} may be mapped to the k OFDM symbols in a subframe, respectively.

TX step 6: n-point IFFT and add CP may be performed, then the transmitting signal S_{TX} will be generated and the transmitting signal S_{TX} may comprise N samples.

RX step 1: signal may be received during a certain time window, and the received samples may be denoted as r₁, r₂, . . . r_{M}, wherein M may be larger than N for timing errors.

RX step 2: Differential processing. Conjugate multiplication may be performed between rᵢ and rᵢ₊ₘ to generate the resulting signal which may be denoted as r_{dif}. r_{dif}(i)=rᵢ*rᵢ₊ₘ, for i=1, 2, . . . , M−m.

RX step 3: Generate local sequence. The S_{TX}(sp₁, sp₂, . . . sp_{N}) may be used to do the differential operation and the resulting sequence may be denoted as localᵢ=spᵢ*spᵢ₊ₘ*, for i=1, 2, . . . , N−m.

RX step 4: the local sequence may be used to perform the sliding correlation operation with the receiving signal r_{dif} and find the correlation peak.

RX step 5: if the detected peak is larger than the predefined threshold, then UE may decide the power saving signal is a LP-WUS and use the LP-WUS to synchronize time and frequency. Otherwise, the UE may determine the power-saving signal is discontinuous transmission (i.e., the network node may send nothing).

The LP-WUS may comprise an LP-WUS index, a cell ID, a UE group ID, and timing information (SFN and subframe index) through symbol-level scrambling sequences. The LP-WUS sequence may be multiplied with a scrambling sequence θₙ_{_{f}}_{,n}_{ₛ}(i), for i=0, 1, . . . , T−1, where T is the LP-WUS length. The scrambling sequence θₙ_{_{f}}_{,n}_{ₛ}(j) may be generated by a binary sequence cₙ_{_{f}}_{,n}_{ₛ}(j) for j=0, 1, . . . , 2T−1, where θₙ_{_{f}}_{,n}_{ₛ}(i)=1, if cₙ_{_{f}}_{,n}_{ₛ}(2i)=0 and θₙ_{_{f}}_{,n}_{ₛ}(2i+1)=0, θₙ_{_{f}}_{,n}_{ₛ}(i)=−1, if cₙ_{_{f}}_{,n}_{ₛ}(2i)=0 and cₙ_{_{f}}_{,n}_{ₛ}(2i+1)=1, θₙ_{_{f}}_{,n}_{ₛ}(i)=j, if cₙ_{_{f}}_{,n}_{ₛ}(2i)=1 and cₙ_{_{f}}_{,n}_{ₛ}(2i+1)=0, θₙ_{_{f}}_{,n}_{ₛ}(i)=−j, if cₙ_{_{f}}_{,n}_{ₛ}(2i)=1 and cₙ_{_{f}}_{,n}_{ₛ}(2i+1)=1. The binary sequence cₙ_{_{f}}_{,n}_{ₛ}(j) may be a Gold sequence initialized at the start of each LP-WUS subframe, and the initializing seed may be cᵢₙᵢₜ=((N_{ID}^{Ncell}+1) (N_{ID}^{Group}+1 ((10n_{f}+└nₛ/2┘)mod 8192+1) 2⁹+N_{ID}^{Ncell}))mod 2³¹. The initializing seed may comprise the N_{ID}^{cell}∈{0, 1, . . . , 1007} which may convey the cell ID to differentiate cells, N_{ID}^{Group} which may convey the UE group ID to differentiate the UE groups, (10n_{f}+└nₛ/2┘)mod 8192 which may convey the timing information to differentiate the POs and the LP-WUS repetitions.

The different root indices of the ZC sequence may be applied to the LP-WUS of different cells to reduce inter-cell interference further. If the LP-WUS sequence length is L, the root index root_{ID} of the ZC sequence in a cell may be given by root_{ID}=N_{ID}^{Ncell} mod(L−1)+1.

The LP-WUS may include 11 symbols, 12 REs, and 132 bits given by d_{WUS}(n)=c(n)·e^{-j2πθn}·e^{-jπun′(n′+1)/131}, wherein n=0, 1, . . . , 131, n′=(n)mod 131, u=(N_{ID}^{cell})mod 126+3, and θ=0. The sequence c(n) may be a RE-level scrambling sequence which may convey part of the cell ID, UE sub-group, and timing information. The sequence c(n) may be initialized at the start of the LP-WUS with cᵢₙᵢₜ=(N_{ID}^{Ncell}+1) ((10n_{f}+└nₛ/2┘)mod 2048+1) 2⁹+N_{ID}^{Ncell}.

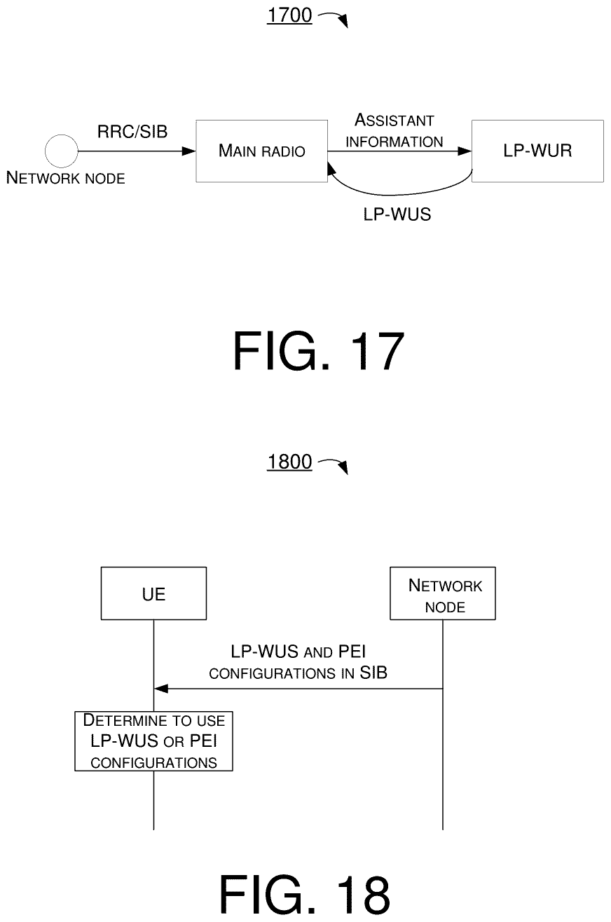

FIG. 17 illustrates an example scenario 1700 of an interface between the main transceiver and the LP-WUR under schemes in accordance with implementations of the present disclosure. Scenario 1700 involves a network node (e.g., a macro base station and multiple micro base stations) and a UE, which may be a part of a wireless communication network (e.g., an LTE network, a 5G/NR network, an IoT network or a 6G network). Referring to FIG. 17, the UE may include an interface to connect the LP-WUR and the main transceiver (or main radio). The interface may be used to transfer assistant information from the main transceiver to the LP-WUR. The assistant information may comprise the LP-WUS configurations, e.g., monitoring time, frequency, and sequences.

The main transceiver may transmit the assistant information to the LP-WUR before the main transceiver is turned off or enters sleep mode. For the RRC IDLE mode, the main transceiver may receive the assistant information from the network node when the UE camps on a serving cell and reads the broadcast system information from the network node. For the RRC CONNECTED mode, the main transceiver may receive the assistant information from the network node when the UE receives the UE-specific configurations (e.g., DRX configurations or the UE-specific LP-WUS configurations) from the network node through RRC, or receives the cell-specific system information (e.g., SIB1, SIB2, or other SIBs) from the network node.

The interface may be used to transmit the LP-WUS detected by the LP-WUR. The LP-WUR may transmit the detected LP-WUS before the LP-WUR is turned off or enters a sleep mode. The interface may be used to transmit acknowledgment between the LP-WUR and the main transceiver. The acknowledgment may comprise ACK or NACK. The acknowledgment may provide possible retransmission of the assistant information and the detected LP-WUS on the interface.

The N mapping configurations may be in SIB or RRC, where N is greater than one. In the eDRX or DRX, the default UE configuration may be a one-to-one mapping between the LP-WUS and the PO. In the eDRX or DRX, an optional UE configuration may be a 1-to-N mapping between the LP-WUS and the PO.

The UE may determine whether the eDRX is configured or not to determine the mapping between the LP-WUS and the PO or between the LP-WUS and the paging early indication (PEI). If the eDRX is configured to UE, the mapping between the LP-WUS and the PO or the mapping between the LP-WUS and the PEI may be 1-to-N mapping, where N is greater than one. If the eDRX is not configured to the UE, the mapping between the LP-WUS and the PO may be 1-to-1 mapping.

FIG. 18 illustrates an example scenario 1800 of LP-WUS and PEI configurations under schemes in accordance with implementations of the present disclosure. Scenario 1800 involves a network node (e.g., a macro base station and multiple micro base stations) and a UE, which may be a part of a wireless communication network (e.g., an LTE network, a 5G/NR network, an IoT network or a 6G network). Referring to FIG. 18, the UE may be configured both the PEI and the LP-WUS from the network node. The UE may determine to ignore the PEI and apply the LP-WUS when the UE satisfies a low mobility criterion, a RSRP threshold, or other reasons that make LP-WUS superior to PEI. Otherwise, the UE may determine to apply the PEI configurations.

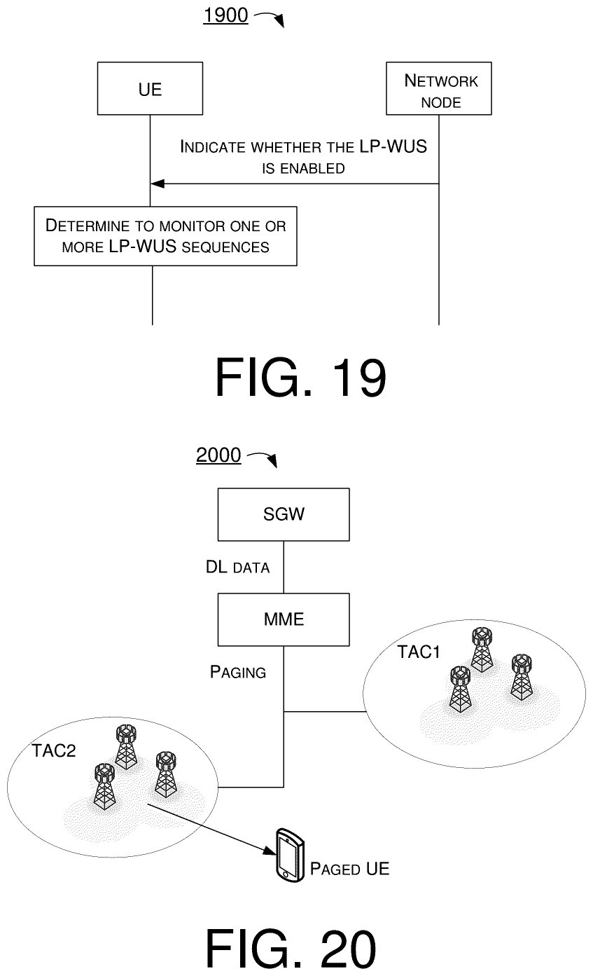

FIG. 19 illustrates an example scenario 1900 of a UE-group LP-WUS configuration under schemes in accordance with implementations of the present disclosure. Scenario 1900 involves a plurality of network nodes (e.g., a macro base station and multiple micro base stations) and a plurality of UEs, which may be a part of a wireless communication network (e.g., an LTE network, a 5G/NR network, an IoT network or a 6G network). Referring to FIG. 19, the network node may transmit the LP-WUS with the required number of repetitions to different UE groups. That is, the network node may indicate whether the UE-group LP-WUS is enabled, and then the UE may monitor one or more LP-WUS sequenced based on the indication from the network node. When the UEs are grouped based on their SNR, SINR, RSRP levels, or coverage information, the network node may transmit the LP-WUS with an actual duration which is smaller than the maximum WUS duration.

In an implementation, the UE may receive the maximum LP-WUS duration and the minimum LP-WUS duration from the network node through the RRC or SIB. The UE may determine whether to use LP-WUS for synchronization based on the maximum LP-WUS duration and the minimum LP-WUS duration.

The UE may receive a UE group ID and the corresponding configurations of LP-WUS duration, repetition, and period from the network node through the RRC messages. The UE may use the received UE group ID and the corresponding configurations to detect LP-WUS.

The UE may monitor one or multiple LP-WUS sequences. The UE may receive the WUS sequence configurations from the network node through the SIB or RRC messages.

The UEs with the same UE_ID may share the same configuration for paging frame (PF) and paging opportunities (PO) based on the paging parameters in the same network. Because of the finite physical resources for PDCCH and PDSCH, only the practical number of UEs can be paged at any given time in PF and PO.

The UE grouping may be used for paging a smaller number of UEs per PO. The UE grouping for the paging may be realized by two ways, the mobility management entity (MME)-level UE grouping and the radio access network (RAN)-level UE grouping. In the MME-level UE grouping, the tracking area (TA) across several network nodes may be indicated in a tracking area code (TAC). In the RAN-level UE grouping, the paging messages may be scheduled by the network node.

FIG. 20 illustrates an example scenario 2000 of an MME-level UE grouping for the paging under schemes in accordance with implementations of the present disclosure. Scenario 2000 involves a plurality of network nodes (e.g., a macro base station and multiple micro base stations) and a plurality of UEs, which may be a part of a wireless communication network (e.g., an LTE network, a 5G/NR network, an IoT network or a 6G network). Referring to FIG. 20, the MME-level UE grouping may be used for paging within a TA. The MME may provide a list of TACs (e.g., TAC1 and TAC2 in FIG. 20) where the UE registration is valid to the UE. When the MME pages a UE, a paging message may be transmitted to all network nodes in a TA list (TAL). In an example, the MME or the RAN may first try to transmit the paging in the last network node where the paging has been successfully received, and then try to transmit the paging in other network nodes with TACs in the TAL. The tracking area may be updated when a UE enters a cell with a TAC which is not in the current TA list. The UE may try to detect the paging in the associated PO.

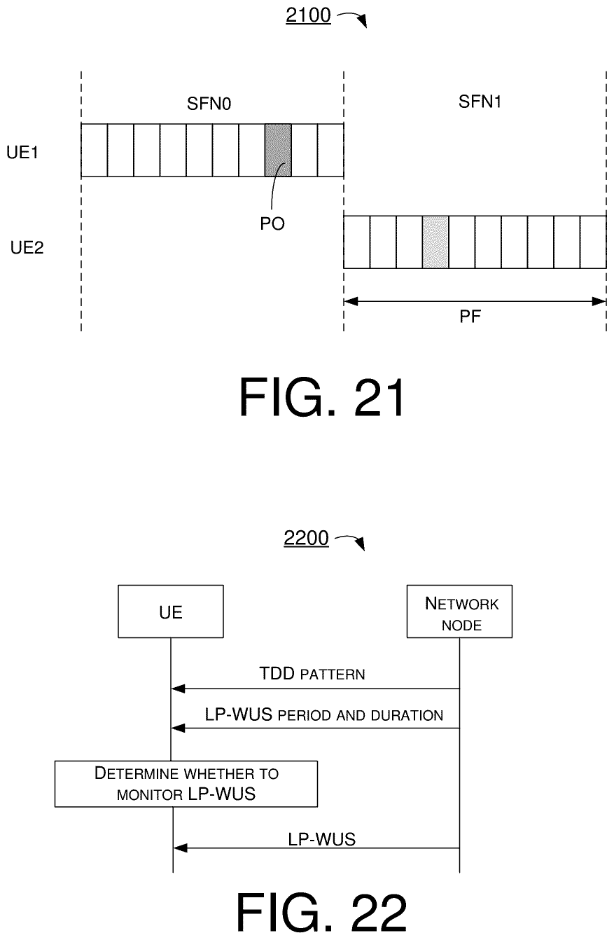

FIG. 21 illustrates an example scenario 2100 of a RAN-level UE grouping for the paging under schemes in accordance with implementations of the present disclosure. Scenario 2100 involves a plurality of network nodes (e.g., a macro base station and multiple micro base stations) and a plurality of UEs, which may be a part of a wireless communication network (e.g., an LTE network, a 5G/NR network, an IoT network or a 6G network). Referring to FIG. 21, the UE_ID (e.g., UE1 and UE2) may be used to identify each UE at RAN level for the RAN-level UE grouping for the paging. The PF may be associated with the system frame number (SFN) and UE_ID. The PF may be one radio frame and may comprise one or multiple POs. When the DRX is used, the UE may need only to monitor one PO per DRX cycle. The number of POs in a PF may be configurable. The UE may need to receive the PDCCH and the associated PDSCH for the paging.

The paging configuration with more than one UE group may be associated with the UE_ID and RRC DRX configuration for the LP-WUS group. A UE in a UE group for the paging may need to wake up if another UE in the same group is paged following the detection of associated LP-WUS. The number of UE groups may be configurable and broadcasted in SIB. A UE in a UE group may be configured a UE-group LP-WUS within PO by the network node through a dedicated RRC signaling.

For the UE-group LP-WUS, the UE may report its capability through the RRC messages to indicate whether the UE supports UE-group LP-WUS. The UE may determine whether the serving cell supports UE-group LP-WUS and the maximum number of UE groups in SIB. If the UE reports that it can support UE-group LP-WUS, the UE may also support the single UE LP-WUS.

The UE may receive the UE-group LP-WUS, DRX, and DRX gap configurations from the network node through the RRC and SIB. For the same DRX gap configuration, the UE may determine that the UE-group LP-WUS transmitted via TDD or code division multiplexing (CDM) manners may be from the received REs. The multiple LP-WUSs may share the same RE via TDD or CDM.

The UE-group LP-WUSs may be only multiplexed in the same carrier as associated PO. The time division multiplexing (TDM) or CDM may be used for UE-group LP-WUS multiplexing.

The UE may determine the UE group ID based on the received LP-WUS sequences. One UE-group LP-WUS may be designed as a single sequence. The UE may determine the LP-WUS based on the ZC sequences, cover codes, the shifted scrambling codes, the phase shift, and their combinations.

If more than one UE group occupies the LP-WUS resource (e.g., time-frequency resource), an LP-WUS may be used to wake up all group WUS UEs which monitors the same LP-WUS resource. The UE may monitor the LP-WUS at most one LP-WUS resource location. The UE-group LP-WUS may multiplex or share the same RE through TDM, CDM, or their combinations.

Each UE may monitor more than one LP-WUS sequence. The number of the max monitoring LP-WUS sequences may be configurable through the RRC or SIB. The UE may determine different LP-WUS resources using different scrambling initializations c_inits. The scrambling initialization c_init is a function of cell ID, paging frames, paging occasions, UE ID, and LP-WUS resource ID, and it may be configured through the RRC or SIB.

The UE may receive 1 bit in SIB which is used to enable or disable UE grouping among more than one LP-WUS resource for UE-group LP-WUS.

FIG. 22 illustrates an example scenario 2200 of collisions handling between the LP-WUS and SSB/SIB under schemes in accordance with implementations of the present disclosure. Scenario 2200 involves a network node (e.g., a macro base station and multiple micro base stations) and a UE, which may be a part of a wireless communication network (e.g., an LTE network, a 5G/NR network, an IoT network or a 6G network). Referring to FIG. 22, the network node may transmit the TDD pattern to the UE through RRC. In addition, the network node may transmit the LP-WUS period and duration to the UE. The UE may determine whether to monitor LP-WUS based on the information from the network node.

The UE may determine to drop or postpone the LP-WUS in the subframes or slots when the subframes or slots are not DL subframes or slots and do not carry SIB in the TDD operation. The UE may determine to drop or postpone LP-WUS if the LP-WUS overlaps with a common (cell-specific) signal or channel. The common signal may comprise SSB, SIB, or PDCCH.

The UE may determine to drop or postpone the LP-WUS if LP-WUS overlaps with a signal or a channel whose quasi co-location type D (QCL-D) assumption is different from the QCL-D assumption of the LP-WUS. The QCL-D assumption of the LP-WUS may indicate the receiving beam direction and the corresponding receiver filter in the spatial domain. The UE may receive the QCL-D assumption through the RRC or SIB or receive an association between the LP-WUS and other reference signals, e.g., SSB, CSI-RS, or TRS.

The UE may determine to drop or postpone the LP-WUS if the LP-WUS overlaps with the LTE cell-specific reference signal (CRS) in the E-UTRAN New Radio-dual connectivity (EN-DC). The UE may drop or postpone the LP-WUS if any LP-WUS monitoring occasion is outside the (e)-DRX ON duration.

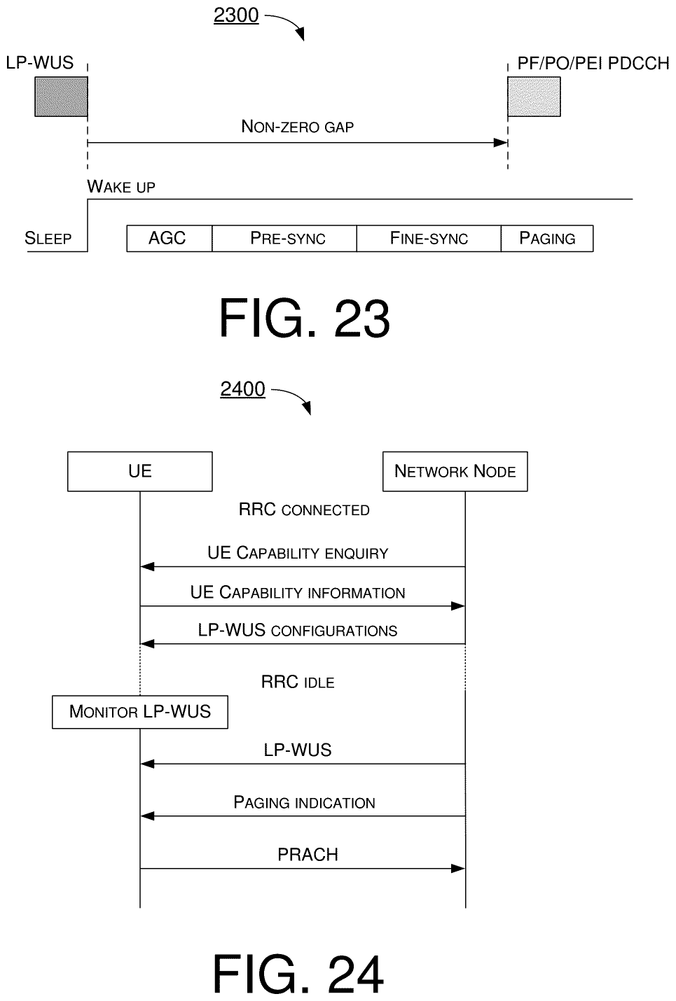

FIG. 23 illustrates an example scenario 2300 of a non-zero gap under schemes in accordance with implementations of the present disclosure. Scenario 2300 involves a network node (e.g., a macro base station and multiple micro base stations) and a UE, which may be a part of a wireless communication network (e.g., an LTE network, a 5G/NR network, an IoT network or a 6G network). Referring to FIG. 23, a non-zero gap between the end of LP-WUS and associated PDCCH in paging opportunity (PO) or PEI may be needed for the processing time in the LP-WUS detection baseband modules in the device modem of the UE and for the inner warming-up time of the baseband modules in the device modem of the UE. The baseband modules may be used for the detection of the associated PDCCH in PO or PEI.

After the LP-WUS detection, the inner warming-up time may be needed to obtain accurate and coherent combining length for channel estimation and to obtain better SNR estimations for the detection of PDCCH. In an implementation, the LP-WUS may be transmitted and detected in a low-power baseband module as LP-WUR.

The UE may receive the non-zero gap between LP-WUS and paging frame (PF), paging occasion (PO), or paging early indication (PEI) in system information, e.g., SIB1 or SIB22 from the network node. The non-zero gap value may be in ms, s, slots, subframes, or periods of monitoring occasions.

The UE may ignore a detected LP-WUS if there is no sufficient time to process based on the non-zero gap configuration or report. That is, after detecting an LP-WUS, if the non-zero gap between LP-WUS is smaller than the pre-determined non-zero gap, the UE may not wake up the main transceiver.

If a configured non-zero gap is larger than the UE reported capability of “minimum gap between the LP-WUS and associated PO,” the UE may monitor the LP-WUS with the larger non-zero gap. If the configured non-zero gap is smaller than the UE reported capability of “minimum gap between LP-WUS and associated PO,” the UE may not monitor LP-WUS with the configured non-zero gap for DRX or eDRX.

FIG. 24 illustrates an example scenario 2400 of a LP-WUS process under schemes in accordance with implementations of the present disclosure. Scenario 2400 involves a network node (e.g., a macro base station and multiple micro base stations) and a UE, which may be a part of a wireless communication network (e.g., an LTE network, a 5G/NR network, an IoT network or a 6G network). Referring to FIG. 24, in RRC connected mode, the network node may transmit a UE capability enquiry to the UE. Then, the UE may transmit the UE capability information to the network node. In addition, the network node may transmit the LP-WUS configurations to the UE through the RRC or SIB. In RRC idle mode, the UE may monitor the LP-WUS based on the configuration from the network node.

### Illustrative Implementations

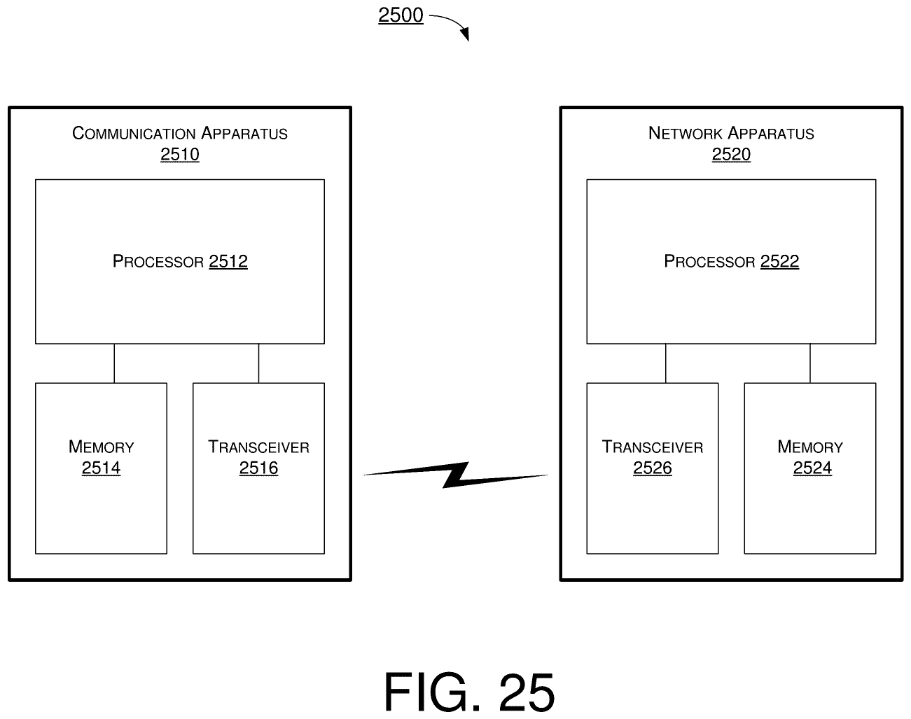

FIG. 25 illustrates an example communication system 2500 having at least an example communication apparatus 2510 and an example network apparatus 2520 in accordance with an implementation of the present disclosure. Each of communication apparatus 2510 and network apparatus 2520 may perform various functions to implement schemes, techniques, processes and methods described herein pertaining to the LP-WUS transmission in mobile communications, including the various schemes described above with respect to various proposed designs, concepts, schemes and methods described above and with respect to user equipment and network apparatus in mobile communications, including scenarios/schemes described above as well as process 2600 and process 2700 described below

Communication apparatus 2510 may be a part of an electronic apparatus, which may be a UE such as a portable or mobile apparatus, a wearable apparatus, a wireless communication apparatus or a computing apparatus. For instance, communication apparatus 2510 may be implemented in a smartphone, a smartwatch, a personal digital assistant, a digital camera, or a computing equipment such as a tablet computer, a laptop computer or a notebook computer. Communication apparatus 2510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 2510 may be implemented in a smart thermostat, a smart fridge, a smart door lock, a wireless speaker or a home control center. Alternatively, communication apparatus 2510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 2510 may include at least some of those components shown in FIG. 25 such as a processor 2512, for example. Communication apparatus 2510 may further include one or more other components not pertinent to the proposed scheme of the present disclosure (e.g., internal power supply, display device and/or user interface device), and, thus, such component(s) of communication apparatus 2510 are neither shown in FIG. 25 nor described below in the interest of simplicity and brevity.

Network apparatus 2520 may be a part of a network apparatus, which may be a network node such as a satellite, a base station, a small cell, a router or a gateway. For instance, network apparatus 2520 may be implemented in an eNodeB in an LTE network, in a gNB in a 5G/NR, IoT, NB-IoT or IIoT network or in a satellite or base station in a 6G network. Alternatively, network apparatus 2520 may be implemented in the form of one or more IC chips such as, for example and without limitation, one or more single-core processors, one or more multi-core processors, or one or more RISC or CISC processors. Network apparatus 2520 may include at least some of those components shown in FIG. 14 such as a processor 2522, for example. Network apparatus 2520 may further include one or more other components not pertinent to the proposed scheme of the present disclosure (e.g., internal power supply, display device and/or user interface device), and, thus, such component(s) of network apparatus 2520 are neither shown in FIG. 14 nor described below in the interest of simplicity and brevity.

In one aspect, each of processor 2512 and processor 2522 may be implemented in the form of one or more single-core processors, one or more multi-core processors, or one or more CISC processors. That is, even though a singular term “a processor” is used herein to refer to processor 2512 and processor 2522, each of processor 2512 and processor 2522 may include multiple processors in some implementations and a single processor in other implementations in accordance with the present disclosure. In another aspect, each of processor 2512 and processor 2522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2512 and processor 2522 is a special-purpose machine specifically designed, arranged and configured to perform specific tasks including autonomous reliability enhancements in a device (e.g., as represented by communication apparatus 2510) and a network (e.g., as represented by network apparatus 2520) in accordance with various implementations of the present disclosure.

In some implementations, communication apparatus 2510 may also include a transceiver 2516 coupled to processor 2512 and capable of wirelessly transmitting and receiving data. In some implementations, the transceiver 2516 may comprise a main transceiver or an LP-WUS transceiver (e.g., LP-WUR). In some implementations, communication apparatus 2510 may further include a memory 2514 coupled to processor 2512 and capable of being accessed by processor 2512 and storing data therein. In some implementations, network apparatus 2520 may also include a transceiver 2526 coupled to processor 2522 and capable of wirelessly transmitting and receiving data. In some implementations, network apparatus 2520 may further include a memory 2524 coupled to processor 2522 and capable of being accessed by processor 2522 and storing data therein. Accordingly, communication apparatus 2510 and network apparatus 2520 may wirelessly communicate with each other via transceiver 2516 and transceiver 2526, respectively. To aid better understanding, the following description of the operations, functionalities and capabilities of each of communication apparatus 2510 and network apparatus 2520 is provided in the context of a mobile communication environment in which communication apparatus 2510 is implemented in or as a communication apparatus or a UE and network apparatus 2520 is implemented in or as a network node of a communication network.

In some implementations, processor 2512 may receive, via transceiver 2516, a WUS configuration from network apparatus 2520. Processor 2512 may monitor a wake-up signal based on the WUS configuration. The wake-up signal may be modulated based on OOK and generated by an MC-ASK waveform generation, and wherein a parameter K is a size of IFFT of CP-OFDMA.

In some implementations, the wake-up signal may contain one or more sequences for detecting or selecting the wake-up signal, and the one or more sequences may be determined/generated based on a sequence detection or a sequence selection, or based on encoded bits.

In some implementations, the wake-up signal may associate with at least one of a UE group ID, cell information, time information, and SFN information.

In some implementations, processor 2512 may perform a synchronization, via an LP-WUR of transceiver 2516, in an event that a main transceiver of transceiver 2516 is in a power saving mode.

In some implementations, processor 2512 may perform, via the LP-WUR of transceiver 2516, the synchronization based on a SSB or PBCH block.

In some implementations, processor 2512 may perform, via the LP-WUR of transceiver 2516, the synchronization based on a LP-SS.

In some implementations, the LP-SS periodicities may comprise at least one of 320 ms, 640 ms, 1280 ms, 2560 ms, 5120 ms, and 10240 ms.

In some implementations, the LP-SS may comprise a LP-WUS preamble.

In some implementations, processor 2512 may determine whether communication apparatus 2510 is in the same cell. Processor 2512 may determine whether to wake up the main transceiver of transceiver 2516 according to whether communication apparatus 2510 is in the same cell and the wake-up signal.

In some implementations, processor 2522 may transmit, via transceiver 2526, a WUS configuration to communication apparatus 2510. Processor 2522 may modulate a wake-up signal based on OOK and generated by an MC-ASK waveform generation, and wherein a parameter K is a size of IFFT of CP-OFDMA. Processor 2522 may transmit, via transceiver 2526, the wake-up signal based on the WUS configuration to communication apparatus 2510.

### Illustrative Processes

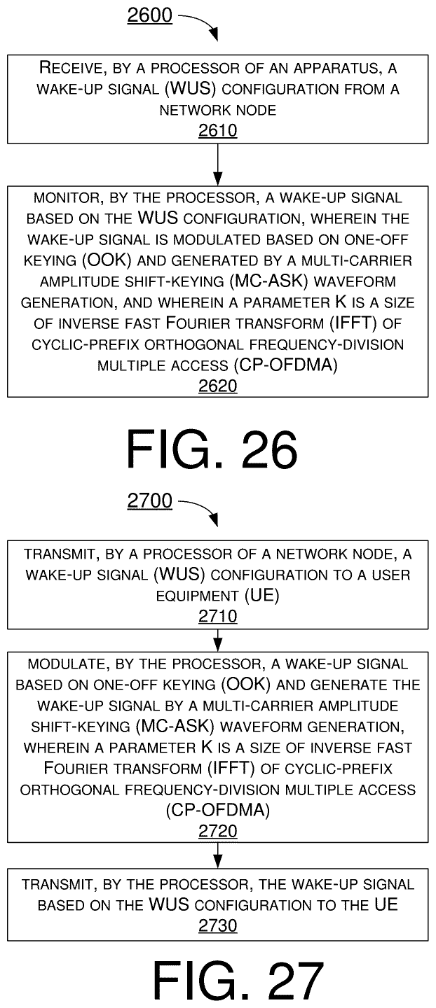

FIG. 26 illustrates an example process 2600 in accordance with an implementation of the present disclosure. Process 2600 may be an example implementation of above scenarios/schemes, whether partially or completely, with respect to the LP-WUS transmission with the present disclosure. Process 2600 may represent an aspect of implementation of features of communication apparatus 2510. Process 2600 may include one or more operations, actions, or functions as illustrated by one or more of blocks 2610 and 2620. Although illustrated as discrete blocks, various blocks of process 2600 may be divided into additional blocks, combined into fewer blocks, or eliminated, depending on the desired implementation. Moreover, the blocks of process 2600 may be executed in the order shown in FIG. 26 or, alternatively, in a different order. Process 2600 may be implemented by communication apparatus 2510 or any suitable UE or machine type devices. Solely for illustrative purposes and without limitation, process 2600 is described below in the context of communication apparatus 2510. Process 2600 may begin at block 2610.

At 2610, process 2600 may involve processor 2512 of communication apparatus 2510 receiving a WUS configuration from a network node. Process 2600 may proceed from 2610 to 2620.

At 2620, process 2600 may involve processor 2512 monitoring a wake-up signal based on the WUS configuration. The wake-up signal may be modulated based on OOK and generated by an MC-ASK waveform generation, and wherein a parameter K is a size of IFFT of CP-OFDMA.

In some implementations, process 2600 may involve processor 2512 performing a synchronization through an LP-WUR of transceiver 2516 in an event that a main transceiver of transceiver 2516 is in a power saving mode.

In some implementations, process 2600 may involve processor 2512 performing the synchronization based on a SSB or PBCH block through the LP-WUR of transceiver 2516.

In some implementations, process 2600 may involve processor 2512 performing the synchronization based on a LP-SS through the LP-WUR of transceiver 2516.

In some implementations, process 2600 may involve processor 2512 determining whether communication apparatus 2510 is in the same cell. Process 2600 may involve processor 2512 determining whether to wake up the main transceiver of transceiver 2516 according to whether communication apparatus 2510 is in the same cell and the wake-up signal.

FIG. 27 illustrates an example process 2700 in accordance with an implementation of the present disclosure. Process 2700 may be an example implementation of above scenarios/schemes, whether partially or completely, with respect to LP-WUS transmission with the present disclosure. Process 2700 may represent an aspect of implementation of features of network apparatus 2520. Process 2700 may include one or more operations, actions, or functions as illustrated by one or more of blocks 2710, 2720 and 2730. Although illustrated as discrete blocks, various blocks of process 2700 may be divided into additional blocks, combined into fewer blocks, or eliminated, depending on the desired implementation. Moreover, the blocks of process 2700 may be executed in the order shown in FIG. 27 or, alternatively, in a different order. Process 2700 may be implemented by network apparatus 2720 or any base stations or network nodes. Solely for illustrative purposes and without limitation, process 2700 is described below in the context of network apparatus 2520. Process 2700 may begin at block 2710.

At 2710, process 2700 may involve processor 2522 of network apparatus 2520 transmitting a WUS configuration to a UE. Process 2700 may proceed from 2710 to 2720.

At 2720, process 2700 may involve t processor 2522 modulating a wake-up signal based on OOK and generating the wake-up signal by an MC-ASK waveform generation, and wherein a parameter K is a size of IFFT of CP-OFDMA. Process 2700 may proceed from 2720 to 2730.

At 2730, process 2700 may involve processor 2522 transmitting the wake-up signal based on the WUS configuration to the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a wake-up signal (WUS) configuration from a network node; and
monitoring, by the processor, a wake-up signal based on the WUS configuration,
wherein the wake-up signal is modulated based on one-off keying (OOK) and generated by a multi-carrier amplitude shift-keying (MC-ASK) waveform generation,
wherein a parameter K is a size of inverse fast Fourier transform (IFFT) of cyclic-prefix orthogonal frequency-division multiple access (CP-OFDMA).

2. The method of claim 1, wherein the wake-up signal contains one or more sequences for detecting or selecting the wake-up signal, and wherein the one or more sequences are determined based on a sequence detection or a sequence selection, or based on encoded bits.

3. The method of claim 1, wherein the wake-up signal associates with at least one of a user equipment (UE) group identity (ID), cell information, time information, and system frame number (SFN) information.

4. The method of claim 1, further comprising:
performing, by the processor, a synchronization through a low-power wake-up receiver (LP-WUR) of the apparatus in an event that a main transceiver of the apparatus is in a power saving mode.

5. The method of claim 4, wherein the performing of the synchronization comprises:
performing, by the processor, the synchronization based on a synchronization signal block (SSB) or physical broadcast channel (PBCH) block through the LP-WUR.

6. The method of claim 4, wherein the performing of the synchronization comprises:
performing, by the processor, the synchronization based on a low-power synchronization signal (LP-SS) through the LP-WUR.

7. The method of claim 6, wherein the LP-SS periodicities comprises at least one of 320 milliseconds (ms), 640 ms, 1280 ms, 2560 ms, 5120 ms, and 10240 ms.

8. The method of claim 6, wherein the LP-SS comprises a LP-WUS preamble.

9. The method of claim 4, further comprising:
determining, by the processor, whether the apparatus is in the same cell; and
determining, by the processor, whether to wake up the main transceiver according to whether the apparatus is in the same cell and the wake-up signal.

10. An apparatus, comprising:
a transceiver which, during operation, wirelessly communicates with at least one network node; and
a processor communicatively coupled to the transceiver such that, during operation, the processor performs operations comprising:
receiving, via the transceiver, a wake-up signal (WUS) configuration from the network node; and
monitoring a wake-up signal based on the WUS configuration,
wherein the wake-up signal is modulated based on one-off keying (OOK) and generated by a multi-carrier amplitude shift-keying (MC-ASK) waveform generation,
wherein a parameter K is a size of inverse fast Fourier transform (IFFT) of cyclic-prefix orthogonal frequency-division multiple access (CP-OFDMA).

11. The apparatus of claim 10, wherein the wake-up signal contains one or more sequences for detecting or selecting the wake-up signal, and wherein the one or more sequences are determined based on a sequence detection or a sequence selection, or based on encoded bits.

12. The apparatus of claim 10, wherein the wake-up signal associates with at least one of a user equipment (UE) group identity (ID), cell information, time information, and system frame number (SFN) information.

13. The apparatus of claim 10, wherein the transceiver comprises a main receiver and a low-power wake-up receiver (LP-WUR), and wherein, during operation, the processor further performs operation comprising:
performing, via the LP-WUR, a synchronization in an event that the main transceiver is in a power saving mode.

14. The apparatus of claim 13, wherein, in performing the synchronization, the processor performs the synchronization based on a synchronization signal block (SSB) or physical broadcast channel (PBCH) block through the LP-WUR.

15. The apparatus of claim 13, wherein, in performing the synchronization, the processor performs the synchronization based on a low-power synchronization signal (LP-SS) through the LP-WUR.

16. The apparatus of claim 15, wherein the LP-SS periodicities comprises at least one of 320 milliseconds (ms), 640 ms, 1280 ms, 2560 ms, 5120 ms, and 10240 ms

17. The apparatus of claim 15, wherein the LP-SS comprises a LP-WUS preamble.

18. The apparatus of claim 13, wherein, during operation, the processor further performs operation comprising:
determining whether the apparatus is in the same cell; and
determining whether to wake up the main transceiver according to whether the apparatus is in the same cell and the wake-up signal.

19. A method, comprising:
transmitting, by a processor of a network node, a wake-up signal (WUS) configuration to a user equipment (UE); and
modulating, by the processor, a wake-up signal based on one-off keying (OOK) and generating the wake-up signal by a multi-carrier amplitude shift-keying (MC-ASK) waveform generation, wherein a parameter K is a size of inverse fast Fourier transform (IFFT) of cyclic-prefix orthogonal frequency-division multiple access (CP-OFDMA); and
transmitting, by the processor, the wake-up signal based on the WUS configuration to the UE.

20. The method of claim 19, wherein the wake-up signal contains one or more sequences for detecting or selecting the wake-up signal, and wherein the one or more sequences are determined based on a sequence detection or a sequence selection, or based on encoded bits.
